(19) United States
(12) Patent Application Publication
(10) Pub. No.: US 2025/0202076 A1
(43) Pub. Date: Jun. 19, 2025

(54) TAB-FREE ELECTRODES FOR BATTERY CELLS

(71) Applicant: GM Global Technology Operations LLC, Detroit, MI (US)

(72) Inventors: Subrahmanyam Goriparti, Troy, MI (US); Hwanchul Kim, Dryden, MI (US); Vincent Edward Herrman, Clawson, MI (US)

(21) Appl. No.: 18/540,140

(22) Filed: Dec. 14, 2023

(51) Int. Cl. H01M 50/538; H01M 10/04; H01M 50/103; H01M 50/536

(52) U.S. Cl. CPC H01M 50/538; H01M 10/045; H01M 10/049; H01M 50/103; H01M 50/536; H01M 2220/20

(57) ABSTRACT

A battery cell includes a housing enclosing an anode and a cathode, and an electrode assembly disposed in the housing, the electrode assembly including a plurality of electrode layers forming a cell stack. Each electrode layer has a coated portion forming part of the cell stack and an uncoated connection portion extending away from the cell stack, the coated portion having a first height, the uncoated connection portion configured to be electrically connected to another electrode layer, the uncoated connection portion having a second height that is equal to the first height.

### INTRODUCTION

The subject disclosure relates to batteries, and more particularly to manufacture and assembly of battery cells.

Battery cells are used in various applications, such as automotive applications (e.g., in electric and hybrid vehicles). For example, electric and hybrid vehicle battery systems include battery modules having multiple battery cells. Battery cells may be pouch-type cells, prismatic cells or other types of cells, and include multiple layers of both anode material and cathode material. Each electrode includes a coated metal foil, and a tab that is used to electrically connect the electrodes. Anode layers are electrically connected by welding a stack of anode tabs, and cathode layer are electrically connected by welding a stack of cathode tabs. Typically, tabs are formed by notching or cutting metal foil material.

### SUMMARY

In one exemplary embodiment, a battery cell includes a housing enclosing an anode and a cathode, and an electrode assembly disposed in the housing, the electrode assembly including a plurality of electrode layers forming a cell stack. Each electrode layer has a coated portion forming part of the cell stack and an uncoated connection portion extending away from the cell stack, the coated portion having a first height, the uncoated connection portion configured to be electrically connected to another electrode layer, the uncoated connection portion having a second height that is equal to the first height.

In addition to one or more of the features described herein, the coated portion includes an active material coating a surface of the coated portion.

In addition to one or more of the features described herein, the uncoated connection portion extends away from the cell stack by a length, the length selected to allow the uncoated connection portion to be connected to a terminal.

In addition to one or more of the features described herein, the length is less than or equal to 5 mm.

In addition to one or more of the features described herein, an electrode layer is formed by acquiring a sheet of a conductive material, coating a first portion of the sheet of the conductive material to form the coated portion, and leaving a second portion of the sheet of the conductive material uncoated to form the uncoated portion.

In addition to one or more of the features described herein, the uncoated portion is formed without removing any of the conductive material of the sheet.

In addition to one or more of the features described herein, the housing is a rectangular prismatic housing.

In addition to one or more of the features described herein, the battery cell is configured to be installed in a battery assembly having a plurality of battery cells, and is configured to be disposed in a vehicle to supply power for propulsion of the vehicle.

In another exemplary embodiment, a method of manufacturing a battery cell includes acquiring a sheet of an electrode material, partially coating the sheet of the electrode material with an active material, the partially coating resulting in a coated region and an uncoated region of the sheet of the electrode material, and forming a plurality of electrode layers from the sheet of the electrode material by defining a plurality of sections, each section having a coated portion and an uncoated portion. The method also includes assembling the plurality of sections such that the coated portions define electrode layers in a cell stack having a first height, and uncoated portions define uncoated connection portions extending away from the cell stack, the uncoated connection portions having a second height that is equal to the first height.

In addition to one or more of the features described herein, an uncoated connection portion is defined without removing any electrode material from a respective section of the sheet.

In addition to one or more of the features described herein, the method includes electrically connecting the plurality of electrode layers by welding the plurality of uncoated connection portions to a terminal, and installing the connected electrode layers in a housing.

In addition to one or more of the features described herein, the housing is a rectangular prismatic housing.

In addition to one or more of the features described herein, electrically connecting the plurality of electrode layers includes folding the uncoated connection portions against the terminal.

In addition to one or more of the features described herein, each uncoated connection portion extends away from the cell stack by a length, the length selected to allow each uncoated connection portion to be connected to a terminal.

In addition to one or more of the features described herein, the length is less than or equal to 5 mm.

In yet another exemplary embodiment, a vehicle system includes a battery assembly including a battery cell, the battery cell including a housing enclosing an anode and a cathode. The battery cell includes an electrode assembly disposed in the housing, the electrode assembly including a plurality of electrode layers forming a cell stack, each electrode layer having a coated portion forming part of the cell stack and an uncoated connection portion extending away from the cell stack, the coated portion having a first height, the uncoated connection portion configured to be electrically connected to another electrode layer, the uncoated connection portion having a second height that is equal to the first height.

In addition to one or more of the features described herein, the coated portion includes an active material coating a surface of the coated portion.

In addition to one or more of the features described herein, the uncoated connection portion extends away from the cell stack by a length, the length selected to allow the uncoated connection portion to be connected to a terminal.

In addition to one or more of the features described herein, an electrode layer is formed by acquiring a sheet of a conductive material, coating a first portion of the sheet of the conductive material to form the coated portion, and leaving a second portion of the sheet of the conductive material uncoated to form the uncoated portion.

In addition to one or more of the features described herein, the uncoated portion is formed without removing any of the conductive material of the sheet.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a prismatic battery cell;

FIGS. 2A and 2B depict a cell stack and uncoated connection portions of a battery cell, the uncoated connection portions electrically connected to terminals, in accordance with an exemplary embodiment;

FIGS. 3A and 3B depict components of an example of a conventional battery cell;

FIG. 4 depicts a system for manufacturing a battery cell, in accordance with an exemplary embodiment;

FIG. 5 is a flow diagram of a method of manufacturing a battery cell, in accordance with an exemplary embodiment;

FIG. 6 depicts an example of a conductive sheet used to manufacture electrode layers, in accordance with an exemplary embodiment;

FIG. 7 depicts a motor vehicle including a battery system, in accordance with an exemplary embodiment; and

FIG. 8 depicts a computer system for performing aspects of a manufacturing process, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment and electrical connection of electrodes (anodes and cathodes) in a battery cell. An embodiment of a battery cell includes electrodes disposed in a housing as multiple anode layers and multiple cathode layers. The layers may be sheets or foils made from conductive materials forming a cell stack, and each layer includes a portion that allows layers to be stacked and welded, referred to as a “connection portion.” Each connection portion extends away from the cell stack by a selected distance so that the connection portions can be welded or otherwise electrically connected.

In an embodiment, each connection portion has a dimension that is equal to a dimension of a respective layer in the cell stack. For example, the cell stack is a rectangular stack disposed in a rigid housing (e.g., prismatic can or housing), having a height and a length. Each layer has a “stack portion” that forms part of the cell stack, and an integral connection portion. The connection portion and the stack portion have the same height.

As described herein, dimensions are “equal” to one another when the dimensions are at least substantially the same. For example, a height of a connection portion may have minor differences from the height of the stack portion, due to the precision of manufacturing tools or processes and/or due to built-in tolerances.

Embodiments also include a process or method for manufacturing battery cells. For example, a manufacturing process includes acquiring sheets of electrode material (e.g., copper and aluminum). Each sheet is coated with an active material, leaving a portion of the sheet uncoated. The uncoated portion is used as a connection portion without the need for cutting out a tab.

Embodiments described herein present numerous advantages and technical effects. The embodiments provide for an improved manufacturing process that facilitates proper attachment and electrical connection of electrode tabs, while reducing unused or dead volume. In addition, the electrode layers and connection portions can be formed without the need for notching or cutting, thereby reducing time and complexity in a manufacturing process. In addition, embodiments provide for a more uniform current distribution as compared to conventional tabs.

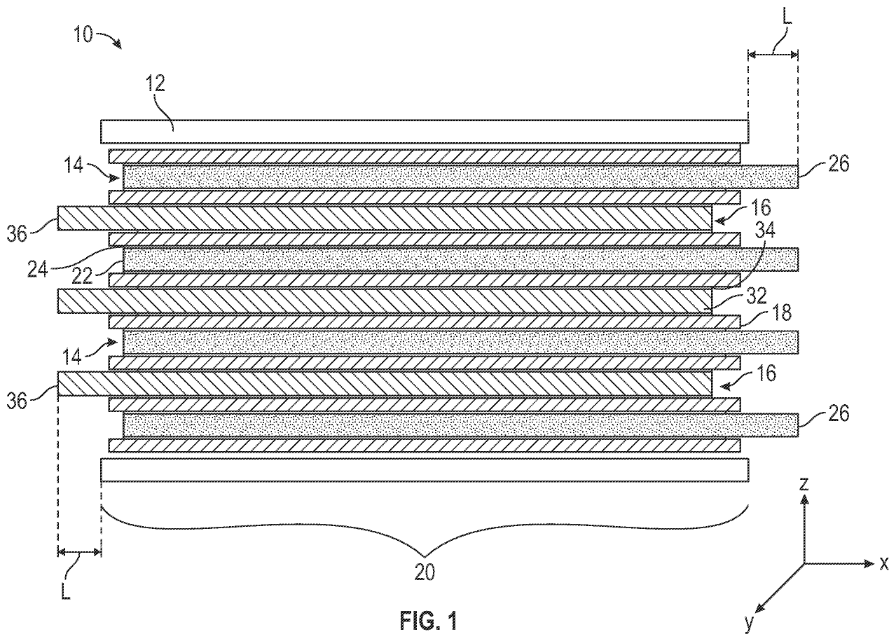

FIG. 1 depicts an example of a battery cell 10. The battery cell includes a housing 12, which may be a rigid housing (e.g., a drawn aluminum housing) that is sealed to enclose a plurality of electrodes. For example, the battery cell 10 is a prismatic cell having a rectangular housing 12. The housing 12 may be made from any suitable material. Embodiments described herein are not limited to any particular type of battery cell, or any particular shape, size or material of the electrodes and the housing. For example, embodiments may be applicable to pouch-type cells and other types of cells.

The battery cell 10 includes a plurality of negative electrodes or anode layers 14, and a plurality of positive electrodes or cathode layers 16. The anode and cathode layers are separated by insulating layers or separators 18. The various layers form a cell stack 20.

The anodes and cathodes are made from selected electrically conductive materials and configured as thin sheets or foils. Each anode layer 14 includes a conductive substrate 22 (e.g., copper sheet) and a coating 24 of an active material on each side of the substrate 22. Likewise, each cathode layer 16 includes a conductive substrate 32 (e.g., aluminum sheet) and a coating 34 of an active material on each side of the substrate 32.

The active materials may be any suitable materials. For example, the anode coatings 20 may be made from graphite or other carbon material, and other materials such as silicon and silicon oxides, and the cathode coatings may be made from a Lithium metal oxide or other suitable Lithium material.

It is noted that the number of electrodes is not limited to the number shown in FIG. 1. The battery cell 10 may have any number of anode layers 14 and any number of cathode layers 16. For example, a battery cell may have hundreds of individual foil layers forming the electrodes.

As shown in FIG. 1, each anode layer 14 includes a portion 26 that extends away from the interior of the cell 10 or the cell stack 20, and allows for electrical connection of each anode layer 14 with another anode layer 14. This portion, referred to as a connection portion 26, is an uncoated portion (i.e., a portion that is exclusively made from copper or other suitable conductive material) that extends a length L from the cell stack 20.

Each cathode layer 16 includes an uncoated connection portion 36 that extends away from the cell stack 20 and allows for electrical connection of the cathode layers 16 to one another. The uncoated connection portions 36 (i.e., portions that are exclusively made from aluminum or other suitable conductive material) extend a length L from the cell stack 20. The uncoated connection portions 36 may have the same length as the uncoated connection portions 26, or a different length.

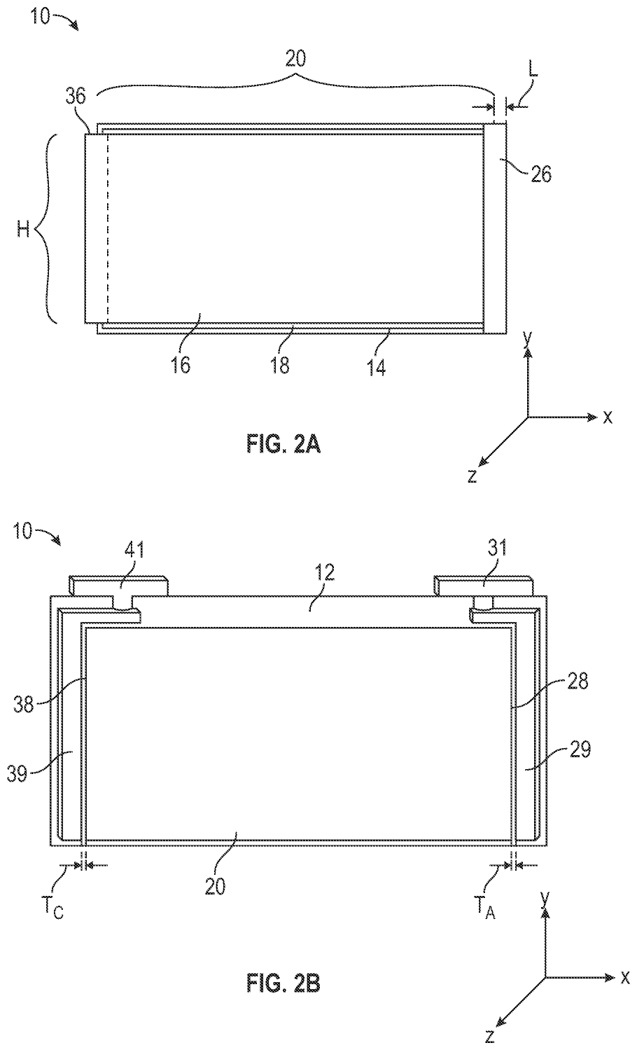

FIGS. 2A and 2B depict an example of the battery cell 10. FIG. 2A shows various layers making up the cell stack 20 and the connection portions 26, and FIG. 2B shows the cell stack 20 electrically connected to battery terminals 29 and 39. The cell stack 20 has a height H. In this example, the cell stack 20 and a set of internal terminals 29 and 39 are disposed in the housing 12.

As shown in FIG. 2A, the connection portions 26 and the connection portions 36 each have the same (or similar) height as the cell stack 20, and extend a distance from the cell stack (length L) that is significantly less than that of conventional tabs. The height of the connection portions 26 and 36 may have the same height as the cell stack 20.

FIG. 2B shows the cell stack 20 as electrically connected to connectors, such as weld plates or terminals. For example, the uncoated connection portions 26 of the anode layers 14 are assembled as a connection stack 28, which is folded and welded to an anode terminal assembly including an anode terminal 29 and a connector 31. The uncoated connection portions 36 of the cathode layers 16 are assembled as a connection stack 38, which is folded and welded to a cathode terminal assembly including a cathode terminal 39 and a connector 41.

The anode connection stack 28, when folded, defines a folding thickness TA between the cell stack 20 and the anode terminal. The cathode connection stack 38, when folded, defines a folding thickness Tc. The folding thicknesses may be substantially the same, and are significantly less than the folding thicknesses of conventional tab stacks. For example, a sum of the folding thicknesses TA and Tc is about 100 microns to about 2 millimeters.

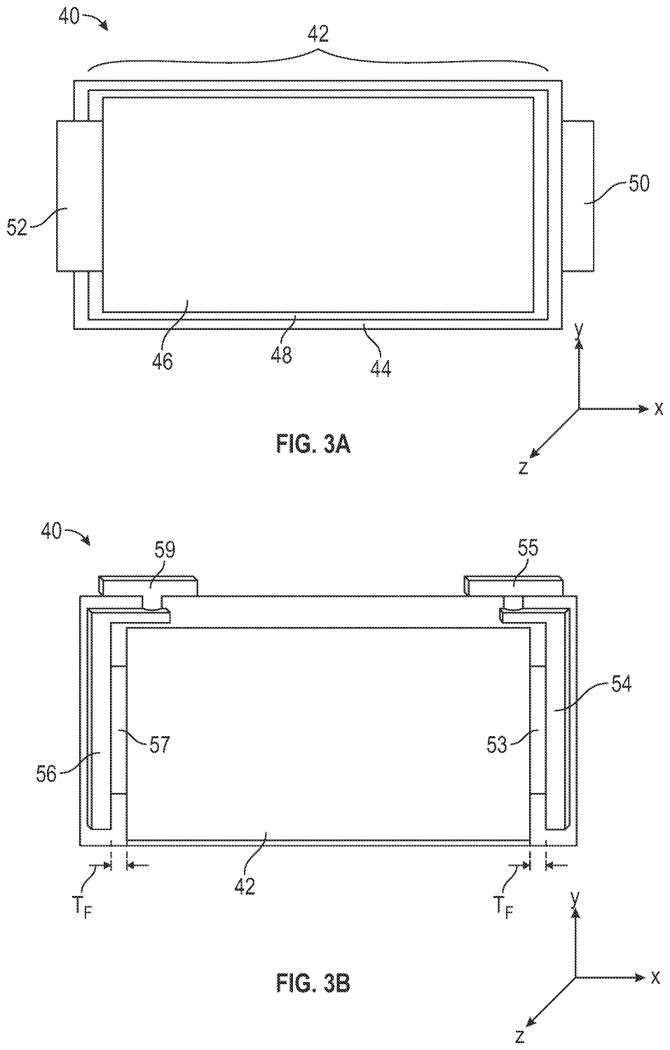

FIGS. 3A and 3B depict an example of a battery cell 40 that includes conventional connection tabs. As shown in FIG. 3A, the battery cell 40 includes a cell stack 42 including anode layers 44, cathode layers 46 and separators 48. The anode layers 44 are connected to anode tabs 50, and the cathode layers 46 are connected to cathode tabs 52.

FIG. 3B shows internal components of the battery cell 40. The anode tabs 50 are folded to form a tab stack 53, and welded to an anode terminal assembly that includes an anode terminal 54 and a connector 55. The cathode tabs 52 are folded to form a tab stack 57, and welded to a cathode terminal assembly that includes a cathode terminal 56 and a connector 59.

In contrast to conventional tabs, the connection portions 26 and 36, FIG. 1, provide for more uniform current distribution, and also reduce the volume necessary for connecting a tab stack to a terminal. For example, the length L (e.g., 3-5 mm) of the connection portions 26 and 36 is significantly less than the distance defined by the conventional tab stacks 53 and 57 (e.g., 5-30 mm). In addition, the height H of the connection portions 26 and 26 are the same as the height of the cell stack 20, providing a sufficient surface area for current distribution.

As a result, the volume needed for stacking, folding and electrically connecting a cell stack to a terminal or other conductor is significantly reduced. For example, the thicknesses TA and Tc of FIG. 2B are much smaller than the folding thicknesses (denoted TF) of the conventional cell 40 shown in FIG. 3B. In addition, the conventional tabs 50 and 52 leave a significant amount of unused volume when stacked and welded as compared to the connection portions 26 and 36.

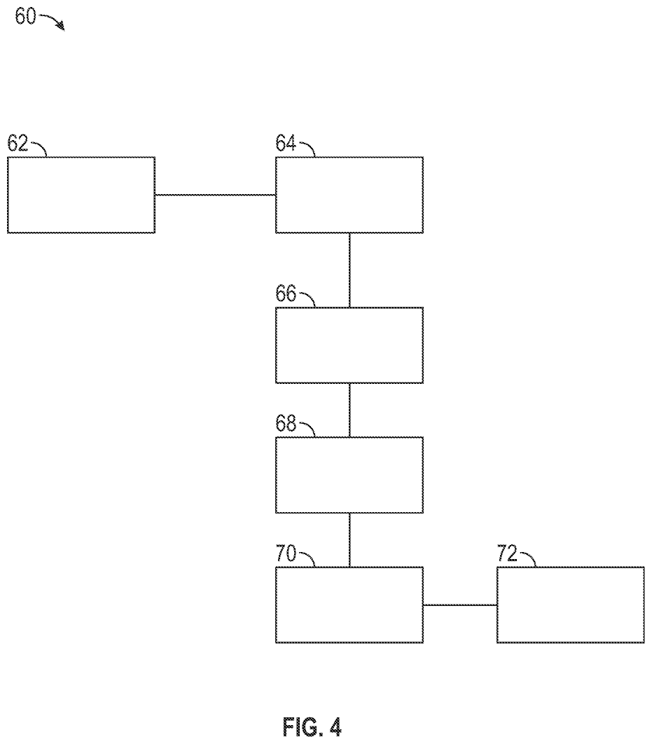

FIG. 4 depicts an example of a manufacturing system 60 for manufacturing battery cells. The manufacturing system 60 includes various manufacturing stations, which may be controlled or operated by a computer system, a human operator or a combination thereof herein.

As described herein, a “station” refers to any number, combination and layout of equipment and is not intended to limit the manufacturing system 60 to any specific machine or combination of machines.

The manufacturing system includes, for example, an active material processing station 62 for preparing active materials to be applied to electrode substrates. The system 50 may also include a coating station 64 for coating electrodes with the active materials. The station 64 may be used to partially coat sheets of electrode material as described herein.

The manufacturing system 60 also includes a cutting station 66, which can be used to form sections that define electrode layers and connection portions. Sections may be formed in any suitable manner, such as by laser cutting, stamping, punching and others.

The system 60 may include other stations for performing subsequent processes to complete battery cells. Examples include a stacking station 68, a welding station 70, and an assembly station 72 (e.g., for cell packaging, sealing, electrolyte filling, etc.).

The manufacturing system 60 may include additional stations for manufacturing battery assembles, such as battery packs and/or modules. For example, a battery cell can be installed in a battery assembly. The battery assembly may be a battery module having a plurality of electrically connected battery cells, such as a battery module that is incorporated into a vehicle (e.g., an electric or hybrid vehicle) as part of a battery pack.

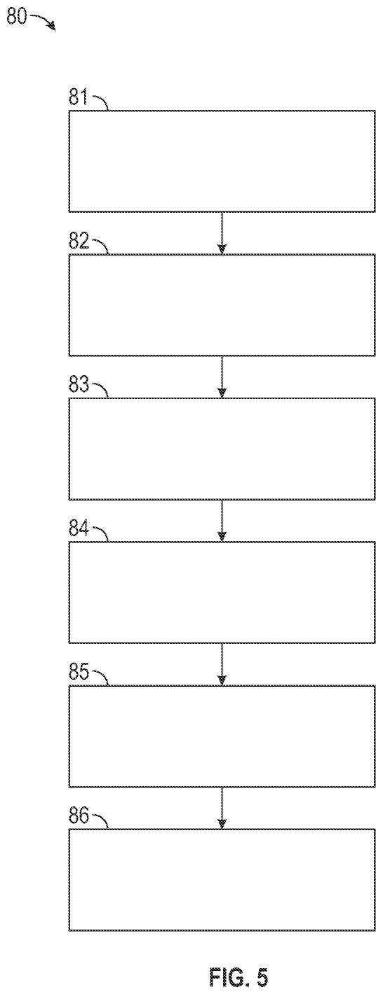

FIG. 5 illustrates embodiments of a method 80 of manufacturing a battery cell, such as the battery cell 10. The method 80 (or parts thereof) may be performed by any suitable processing device or devices, such as a controller of the manufacturing system 50, but is not so limited.

The method 80 includes a number of steps or stages represented by blocks 81-86. The method 80 is not limited to the number or order of steps therein, as some steps represented by blocks 81-86 may be performed in a different order than that described below, or fewer than all of the steps may be performed.

At block 81, sheets of conductive material are acquired for use in forming electrode layers. For example, long sheets of copper (or other suitable material) are acquired and referred to as “anode sheets,” and long sheets of aluminum or other suitable material are acquired and referred to as “cathode sheets”. These sheets are used as substrates for subsequent coating.

At block 82, the anode sheets and the cathode sheets are coated with an active material. The active material may be a metal oxide, such as lithium cobalt oxide (LCO), lithium nickel manganese cobalt oxide (NMC), or lithium iron phosphate (LFP). The anode sheets and the cathode sheets are partially coated, leaving uncoated portions that will form the connection portions.

At block 83, the anode sheet is processed to create a plurality of individual anode layers (e.g., the anode layers 14), and the cathode sheet is processed to create a plurality of individual cathode layers (e.g., the cathode layers 16). The anode layers and the cathode layers are stacked in an alternating pattern with separator layers. For example, the sheets are cut into rectangular portions and stacked, or the sheets are rolled or wrapped to form the layers (and may be subsequently cut to fit a housing).

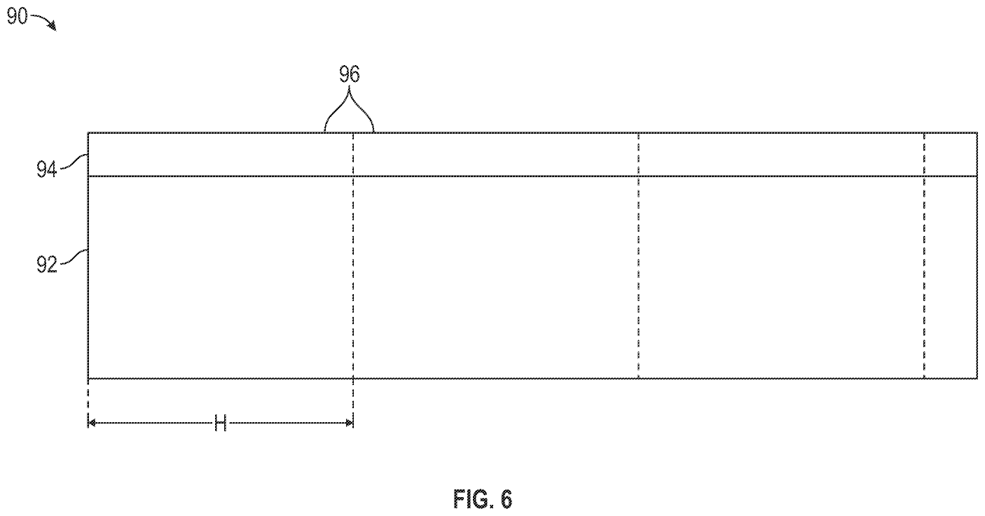

FIG. 6 shows an example of a cathode sheet used to form the cathode layers 16. A similar anode sheet may be used to form the anode layers.

A cathode sheet 90 is fed into a coating device (e.g., the coating station 64 of FIG. 4), where a portion 92 is coated with an active material. The sheet 90 is only partially coated, leaving an uncoated portion 94 that will form the connection portions 36 for cathode layers. Subsequent to the coating, the sheet 90 is divided into sections 96 (shown by dashed lines). Each section has a respective dimension H that will correspond to the height H of the cathode layers. The sheet 90 may be divided by cutting the sheet prior to stacking, or wrapping the sheet 90 to form the layers. No notching or cutting is required to form the connection portions.

Referring again to FIG. 5, at block 84, the uncoated connection portions of anode layers are electrically connected via welding, and the uncoated portions of cathode layers are similarly connected. For example, the uncoated anode connection portions 26 are stacked together and welded to a terminal or weld plate (e.g., the terminal 29), and the uncoated anode connection portions 36 are stacked together and welded to a terminal or weld plate (e.g., the terminal 39). Prior to welding, the stacked portions can be folded as needed to conform to their respective terminals and eliminate any dead space.

At block 85, additional steps are performed to complete assembly of the battery cell, such as installing the welded electrodes in a housing (e.g., a prismatic housing), quality inspection, electrolyte filling, housing sealing and others.

At block 86, the battery cell may be installed in a battery assembly, such as a battery pack or battery module. For example, the battery cell is installed in a battery module with other cells, and the battery module is installed in an electric or hybrid vehicle.

It is noted that the manufacturing system 60 and method 80 are not intended to limit embodiments to any specific manufacturing process. Any suitable manufacturing system or process that includes some form of electrode creation and electrical connection may be used.

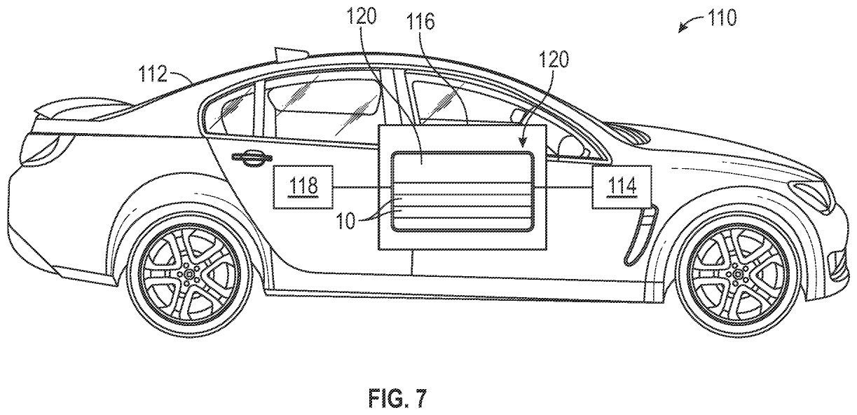

Embodiments of battery cells described herein may be connected to, or part of a vehicle battery system. FIG. 7 shows an embodiment of a motor vehicle 110, which includes a vehicle body 112. The vehicle 110 may be a combustion engine vehicle, an electrically powered vehicle (EV) or a hybrid electric vehicle (HEV). In an example, the vehicle 110 is a hybrid or electric vehicle having an electric motor 114. A battery system 116 is electrically connected to the motor 114 and/or other components, such as vehicle electronics. The battery system 116 includes one or more modules 120, and each module 120 defines or is part of a high voltage battery pack. The module 120 includes a plurality of the battery cells 10.

The vehicle 110 also includes one or more processing devices, such as a controller 118. The controller 118 may perform various functions, such as controlling conversion devices (e.g., one or more inverters and/or one or more direct current (DC)-DC converters), controlling components of a battery management system, monitoring the motor 114 and/or battery system 116, and others. The controller 118 may include a non-transitory computer-readable medium that stores instructions which, when processed by one or more processors of the controller 118, implements methods of operating vehicle components and systems as desired.

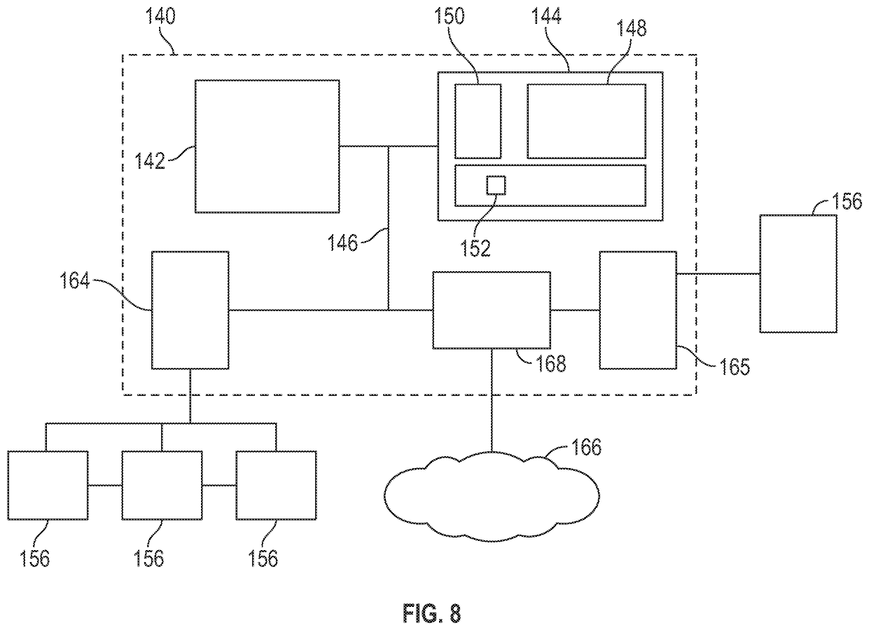

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to controlling one or more manufacturing processes. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this invention belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a housing enclosing an anode and a cathode; and
an electrode assembly disposed in the housing, the electrode assembly including a plurality of electrode layers forming a cell stack, each electrode layer having a coated portion forming part of the cell stack and an uncoated connection portion extending away from the cell stack, the coated portion having a first height, the uncoated connection portion configured to be electrically connected to another electrode layer, the uncoated connection portion having a second height that is equal to the first height.

2. The battery cell of claim 1, wherein the coated portion includes an active material coating a surface of the coated portion.

3. The battery cell of claim 1, wherein the uncoated connection portion extends away from the cell stack by a length, the length selected to allow the uncoated connection portion to be connected to a terminal.

4. The battery cell of claim 3, wherein the length is less than or equal to 5 mm.

5. The battery cell of claim 3, wherein an electrode layer is formed by acquiring a sheet of a conductive material, coating a first portion of the sheet of the conductive material to form the coated portion, and leaving a second portion of the sheet of the conductive material uncoated to form the uncoated portion.

6. The battery cell of claim 5, wherein the uncoated portion is formed without removing any of the conductive material of the sheet.

7. The battery cell of claim 1, wherein the housing is a rectangular prismatic housing.

8. The battery cell of claim 1, wherein the battery cell is configured to be installed in a battery assembly having a plurality of battery cells, and is configured to be disposed in a vehicle to supply power for propulsion of the vehicle.

9. A method of manufacturing a battery cell, comprising:
acquiring a sheet of an electrode material;
partially coating the sheet of the electrode material with an active material, the partially coating resulting in a coated region and an uncoated region of the sheet of the electrode material;
forming a plurality of electrode layers from the sheet of the electrode material by defining a plurality of sections, each section having a coated portion and an uncoated portion; and
assembling the plurality of sections such that the coated portions define electrode layers in a cell stack having a first height, and uncoated portions define uncoated connection portions extending away from the cell stack, the uncoated connection portions having a second height that is equal to the first height.

10. The method of claim 9, wherein an uncoated connection portion is defined without removing any electrode material from a respective section of the sheet.

11. The method of claim 9, further comprising electrically connecting the plurality of electrode layers by welding the plurality of uncoated connection portions to a terminal, and installing the connected electrode layers in a housing.

12. The method of claim 11, wherein the housing is a rectangular prismatic housing.

13. The method of claim 11, wherein electrically connecting the plurality of electrode layers includes folding the uncoated connection portions against the terminal.

14. The method of claim 9, wherein each uncoated connection portion extends away from the cell stack by a length, the length selected to allow each uncoated connection portion to be connected to a terminal.

15. The method of claim 14, wherein the length is less than or equal to 5 mm.

16. A vehicle system comprising:
a battery assembly including a battery cell, the battery cell including:
a housing enclosing an anode and a cathode; and
an electrode assembly disposed in the housing, the electrode assembly including a plurality of electrode layers forming a cell stack, each electrode layer having a coated portion forming part of the cell stack and an uncoated connection portion extending away from the cell stack, the coated portion having a first height, the uncoated connection portion configured to be electrically connected to another electrode layer, the uncoated connection portion having a second height that is equal to the first height.

17. The vehicle system of claim 16, wherein the coated portion includes an active material coating a surface of the coated portion.

18. The vehicle system of claim 16, wherein the uncoated connection portion extends away from the cell stack by a length, the length selected to allow the uncoated connection portion to be connected to a terminal.

19. The vehicle system of claim 16, wherein an electrode layer is formed by acquiring a sheet of a conductive material, coating a first portion of the sheet of the conductive material to form the coated portion, and leaving a second portion of the sheet of the conductive material uncoated to form the uncoated portion.

20. The vehicle system of claim 19, wherein the uncoated portion is formed without removing any of the conductive material of the sheet.
